(19) United States
(12) Patent Application Publication
(10) Pub. No.: US 2014/0143030 A1
(43) Pub. Date: May 22, 2014

(54) Method for Automatically Updating Content, Status, and Comments on Third Parties

(71) Applicant: Michael Zeinfeld, Chicago, IL (US)

(72) Inventor: Michael Zeinfeld, Chicago, IL (US)

(21) Appl. No.: 14/081,831

(22) Filed: Nov. 15, 2013

Related U.S. Application Data
(60) Provisional application No. 61/726,705, filed on Nov. 15, 2012.

(51) Int. Cl. G06Q 50/00; H04L 12/58

(52) U.S. Cl. CPC G06Q 50/01; H04L 51/32
USPC 705/14.1; 705/319

(57) ABSTRACT

A system and method for automatically removing or modifying original social media content based on a pre-determined set of rules. The method enables the original comment to be automatically be removed from public viewing based on pre-determined rules based on “the state” of either user A or user A as it applies to a third entity related to user A. Furthermore, content which is generated by a second party to a specific entity and can be transferred to a third entity based on status. Additionally, other parties can change status of the entity for the user A. Content may also be placed in “content escrow” where content would not be displayed publicly or would be removed when, if, or until a certain pre-condition status was met. Finally, a third user can contact a first user based on the relationship status to a second or middle user.

### CROSS REFERENCE TO RELATED APPLICATIONS

This application claims priority from U.S. Patent Application Ser. No. 61/726,705, entitled “Method for Automatically Updating Social Media Status and Comments on Third Parties”, filed on 15 Nov. 2012. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a method of social media. More specifically, the present invention relates to a method for automatically updating and managing social media status and comments on third parties.

### BACKGROUND OF THE INVENTION

Current systems of marketing, social media and content development provide for media-based content updates. For example, users can post information to their social media profile with a location, a text based message, a video, etc.

These updates are usually broadcast in a one to many fashion, where user A will submit content (“Airline X is the best airline . . . ”) and the intended, often public audience will consume the content.

However, this interaction can be less than optimal because often the initial content is dependent on a user's current “state”. Even though the “state” may have changed, the content continues to live on. For example, let's say that user A has a bad experience with Airline X and posts this experience on a public social media site such as TWITTER: “@AirlineX lost my luggage”.

Airline X may take the time to reply to the message and even address the concerns of the user. However, in this case, for example, the content continues to live on potentially harming Airline X's reputation. And, furthermore, the information is available publicly before Airline X has a chance to respond.

A better solution would be for the original comment to be automatically be removed—or made initially unavailable publicly—based on pre-determined rules based on “the state” of either user A or user A as it applies to a third entity related to user A (for example, a trip user A took).

Another drawback of current content and social media systems is that there is no easy way for users to determine the creditability of the transaction. In other words, after a post about Airline X, there is no easy way for a) Airline X to determine if a user did, in fact, experience lost luggage (or even fly on Airline X recently) b) The public to know if the source of the post is from someone who wishes to defame Airline X (e.g., a competitor). Additionally, there is no motivation within the system to reward users for “credible” content and penalize users for content that is not credible.

This same dynamic rings true in e-commerce transactions. By an e-commerce transaction, in this case the system mean any transaction which would facilitate the transmission of goods/services from one user to another. At the heart of every e-commerce transaction is actually content. A user may put a car up for sale and corresponding content may be the description of the car, the price of the car, a brief history of the car. Additionally, on the opposite side of the transaction, there is information such as what price I'm willing to pay, the description of what I'm looking for, etc. Content associated with an e-commerce transaction is often extremely sensitive.

Current commerce systems may sufficiently allow a user to post transactional related information. For example, a classified web-site allows users to post that one might be selling a car, which is Auto X, for $25,000 or best offer. Additionally, these sites allow users to post that they are, for example, looking for Auto X for $25,000. Additionally, these web sites may provide for “matching” services to automatically connect a buyer with a seller. Additionally, when a buyer and a seller connect, the web-site may automatically remove content associated with the transaction from public view.

However, what these systems do not do is easily facilitate important content and data from one user to another user, as well as public broadcast during this time period. For example, User A may be selling his Auto X. There is actually a vast history of content and data that would be both helpful to publicly provide for User A in selling the car, as well as a buyer's a decision if they want to buy a User A's specific Auto X. For example, the service history of the car, the technical usage date of the car (for example, an automated record of past GPS locations for the car, or social media posts that may be related to the car while the User had been using the car).

For example, it may be advantageous for User A to hide posts about his Auto X when putting up the Auto X for sale. In other words, User A may have TWEETED to @ AutoX a negative comment about his car. Or, for example, perhaps User A has been automatically tracking all usage history, and would like to show this information during the period when the Auto X is for sale. Additionally, once Auto X has been “bought” by a second user, there is no easy way to transfer all of this relevant data from user to user. Certainly, some of this information will be transferred automatically within the asset itself (e.g., mileage information and other diagnostic information), but—in fact—there may be privacy issues with too much detail even from the asset itself, as well as additional information that would be collected or published independent of the asset.

Similar to the above “credibility” drawback of the Airline X example, there is no way for a seller to easily to determine how credible a potential buyer's status and associated content is. For example, a user B (a buyer) may post content that they are looking “to buy a car within the next 30 days”, however there is no way for User A to evaluate the credibility of this claim. Similarly, there is no systemic way to allow user B to “back-up”/reinforce his content with restrictions so that user A knows that User B is a credible buyer.

Another extension of “credibility” is the notion that some buyers and/or sellers may be “shopping around”. And current systems do easily allow a user to filter out those users who have limited their selection set and thus may be more valuable to a buyer/seller. In other words, buyers may be price comparison shopping an item or service in the hopes of finding the best deal. A seller may spend more time, offer a better price or change their behavior in another way if they were confident that the buyer was limiting their consideration set to a single source, a brand, geography or other relevant factors.

### DEFINITIONS

“Entity” is defined as a product, service, etc. (include, for example City,) geographical area, other person, concept, belief etc.).

“Instance” is defined as a more detailed level representation of the Entity. For example, a specific “trip” taken by a user (January 7 trip to California) would be an Instance of an Entity.

“Status” is defined as a user's relationship to an Entity. Examples include: Buying, Selling, Using/Like, Using/Dislike, Using/Neutral, Manufacturing, Advising, Servicing, etc.

“Initiating User” User or users who take an action related to an Entity or Instance

“Receiving User(s)” User or users who take actions related to an Entity or Instance based upon an Initiating User(s) first action

“Possession” is defined as the physical or conceptual (service) actual experience with the product. For a physical product, this means “owning/having inventory”.

“Post” is defined as the creation of content by one user which can apply to one Status or many Status. This Post may be on the current system, and may also post out to other systems (e.g., Facebook, etc.).

“Content” refers to a Post, A Status or any other information that may be communicated from one User to another User.

“Complementary Status” is defined as the pre-defined status which go-together. For example, User A—Buying Car and User B—Selling Car. Complementary Status may not necessarily be for the exact same product, category, etc. For example, User A—Servicing Car may complement User B—Selling Tires.

“Status Connection” is defined as when a user is connected to another user with a complementary status.

“Positive Transaction” is defined as the successful exchange between two or more users based on the pre-defined Complementary Status change for each user.

“Negative Transaction” is defined as the lack of pre-defined Status change for each user based on pre-defined Status Change.

“Base Status Pledge” is defined as the amount of currency (points, money, etc.) which is pledged by a user in relation to a Transaction (usually that it will be Positive).

“Reward Points” are defined as any currency given to a user as a result of a Positive or Negative Transaction.

“Base Status Pledge Reward” is defined as the minimum reward to be given to a User, in addition to their Base Status Pledge, for a Positive transaction.

“Boundaries” are defined as the user selected attributes which will constrain a status, which will place boundaries on status choices. Usually selection of Boundaries will allow for greater rewards.

“Boosts” are defined as multipliers, absolute value rewards, etc. based on Base Status Pledge which usually accompany User chosen boundaries.

### SUMMARY OF THE INVENTION

The present invention is a system and method for automatically removing or modifying original social media content based on a pre-determined set of rules. The present invention teaches a method that enables the original comment to be automatically be removed from public viewing based on pre-determined rules based on “the state” of either user A or user A as it applies to a third entity related to user A.

The present invention may also apply to content which is generated by a second party to a specific entity and can be transferred to a third entity based on status. Additionally, other parties can change status of the entity for the user A.

Another extension of the application of the present invention would be to put any content in “content escrow” where content would not be displayed publicly or would be removed when, if, or until a certain pre-condition status was met.

In yet another application of the present invention, a third user can contact a first user based on the relationship status to a second or middle user.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 discloses a diagram of Status Based Content Display;

FIG. 2 discloses a diagram of potential data for content/status updates;

FIG. 3 discloses a diagram for a currency based content transaction;

FIGS. 4-5 provide exemplary data models for currency based boundaries;

FIG. 6 discloses a diagram of Status Based Content Transfer;

FIG. 7 discloses a diagram of Status Based Content Escrow;

FIG. 8 discloses a diagram of Currency Dependent Status Update Example For A Buyer;

FIG. 9 discloses a diagram of Currency Dependent Status Update Example For A Seller;

FIG. 10 illustrates a linkstatus main table;

FIG. 11 illustrates link status management;

FIG. 12 illustrates Purpose content management;

FIG. 13 illustrates a table showing the attachment of a logIDs to linkstatusIDs; and

FIG. 14 illustrates Tag management.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Currently there are systems which hide or show content to a specific user based on their status in relationship to the user. For example in FACEBOOK there may be a user A who has photos on their profile and only shows these photos to friends. User A may determine that user B is a friend, and therefore the prior and future photos will display for user B. Then, conversely, if user A determines that user B is not a friend, the past and future photos will no longer display for user B.

The present invention is different for the following reasons. The status is based on a related item, not a specific users. For example the status is based on the “car” of user A, not user A. The photos in the example above will display or not display depending on the status of user A and user B to user A and user B, as opposed to, in the present invention, content that will or won't display publicly depending on the status of user A and user B.

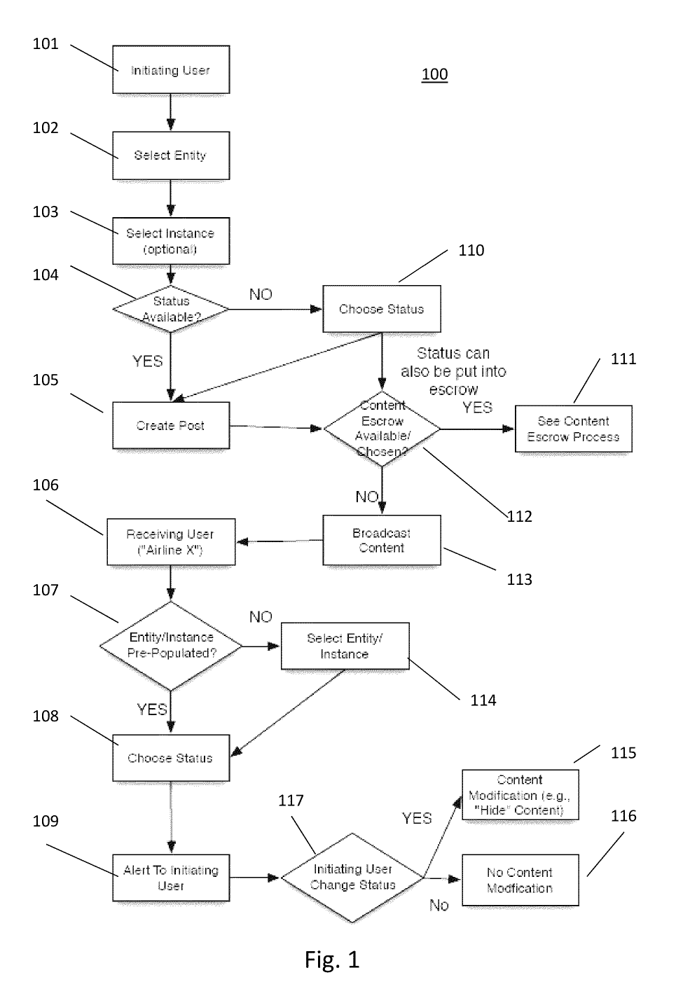

Now referring to FIG. 1, the status based content display method 100 is illustrated. For an initiating user 101 selects an entity 102 and an instance 103. An entity 102 or instance 103 may be automatically presented to a user 101 based on prior history such as location, linking to a purchase history, etc. Proof may also be required for instance selection. For example, a proof of purchase or physical possession of a product may be required.

For example: User A “dislikes” Airline X. User A posts content about Airline X in relation to a trip “1” user A took. Users B, C, D, E, F, G (the public) read User A content about Trip 1. Airline X may or may not receive an alert regarding the Status Change related to Trip 1. Airline X changes status in relation to user A Trip 1 transition to “addressing”. User B, C, D, E, F, G (the public) can no longer view user A trip 1 Content. In the above example, the content display rules apply to users who are not involved in the status. If the user has a current status available 104, then they must create a post 105. If there is no status available, a status must be chosen 110. Next, the system determines if the content escrow is available or is chosen 112 for this instance 103, the user 101, and the entity 102. If escrow is chosen, the process proceeds to the content escrow process method 111. If no escrow is available or chosen, the content is broadcast or published 113 to one or more receiving users 106. If the entity 102 or instance 103 is pre-populated that status is chosen 107, if not, a an entity or instance is selected 114 and a status chosen 108. An alert 109 is then generated and sent to the initiating user 101 who can then change their status 117 by modifying the content if they so elect 115 or no modifying the content 116.

For standard deposit to sales transactions, User A puts a deposit down on house which User B is selling. User A loses house is User A does not proceed with the transaction. This process differs because the transaction was contemplated directly between user A and User B on a specific asset, but not related to the “general status” of user A and User B as confirmed by user B, C, D. There is no ability for other users (e.g., User C, D) to be rewarded for the status change or lack of status change between User A and User B. There is no additional formula which would give User A additional options to limit the status consideration set or timeline to provide an additional reward.

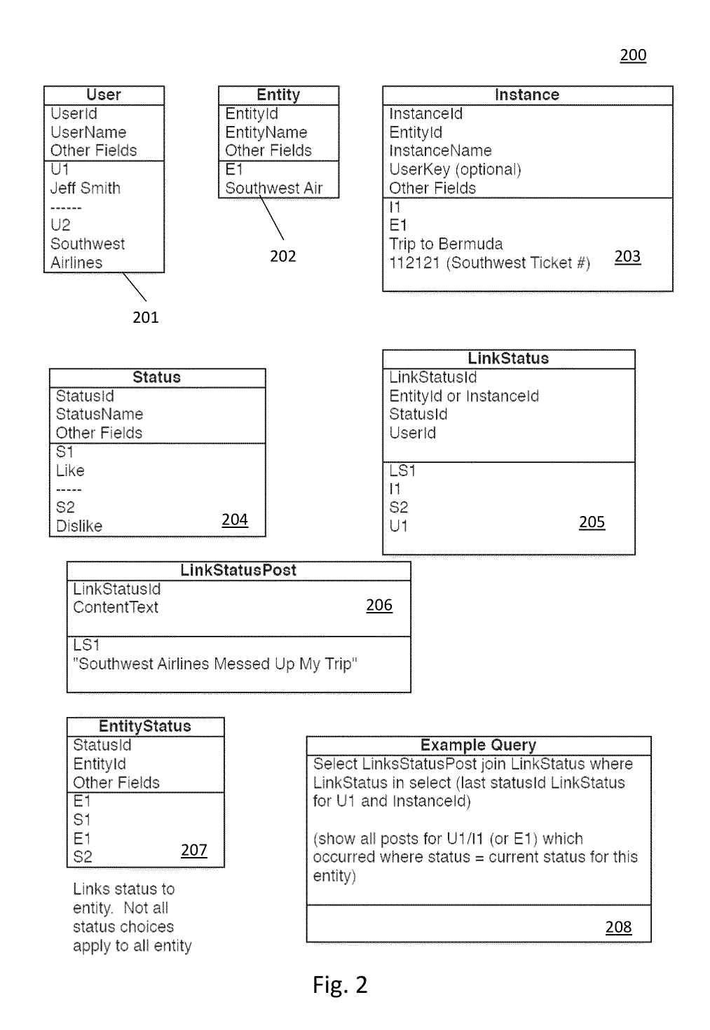

FIG. 2 illustrates the potential data diagram for content/status updates 200. The user 201 includes an ID, name, and other fields. An entity 202 includes an ID, name, and other fields. An instance 203 includes an ID, associated entityID, a name, an optional user key, and other fields as necessary. Status 204 includes an ID, name, and other fields. A LinkStatus 205 includes and ID, associated entityID or instanceID, a status ID, and a user ID. Link Status Post 206 includes a link status ID and content text. Entity Status 207 includes a status ID, entity ID, and other fields as necessary. An Example Query 208 is shown in FIG. 2.

A reverse auction allows for User A to present contract terms (including price) of a specific transaction which are agreed to in advance by proposed sellers. Again, this is in relation to a specific transaction and not a general status.

For example, a status might be “buying an airline ticket”. There may be a fee associated with breaking the contract. However, there is no way for the user to pledge more or less for the fee in return for different a credit or discount on price. Sellers do not directly subsidize or take part in credits or discounts. Sellers are not asked to confirm status changes (or lack of status changes)

In a Status Based Content Display, User A would change their “status” to dislike Airline X, then post the comment. The specific content item is linked back to “the state” of user A or, more specifically, a trip user A took on Airline X. For example user A changes their “status” to “dislike”. User A Posts the content: Airline X lost my luggage. The system here may check to insure that a trip did in fact, occur. This can be done electronically using a receipt for the transaction. Or, if the subject of the content is a physical product, a RFID/scanner can be used to check serial number. Or, for example, if the content is location based (e.g., content related to travelling to a city), GPS coordinates of the user can be checked.). See below for other ways (“Currency Dependent Status”) of validating the content related status.

Next, the Airline X rectifies the problem: User A changes their state to “like”. The content, which is linked to “dislike”, is no longer publicly visible, let's say for example User A takes another trip and the luggage is lost, If User A changes state back to “dislike”, content visibility would be publicly visible again.

Another example is an e-commerce transaction. User A may want to sell a car. User A would first change status to “selling” in relation to the car. User A posts content to the system such as “Looking to sell my car, 30000 miles on it”, in relation to User A's car. User B, who is looking to buy a car, can see the content—as well as any subsequent content—until user A changes status from “selling” to a different status based on pre-defined business rules. Additionally, the business rules may include the status of user B. as well.

So for example: User A changes their status in relation to their “Car” to “Sell” from “Using”. User A: creates content related to specific Car such as “This car for sale is great”. User B: Status changes to “Buying Car”. User B can now see all of user A status which relates to selling car. User B turns off “Buying Car” and User B can no longer view content from User A's Car.

In another example, a manufacturer has just replaced an old model with a new model of an MP3 player, for example. The manufacturer can change the Status of the MP3 player to “discontinued”. Using pre-determined business rules, which can be determined by, for example, how much the manufacturer has paid to the system, usage levels, etc., content which has been created for the discontinued iPod may no longer be visible. Or, for example, status which has been created “dislike” status related to the discontinued iPod can be made no longer visible.

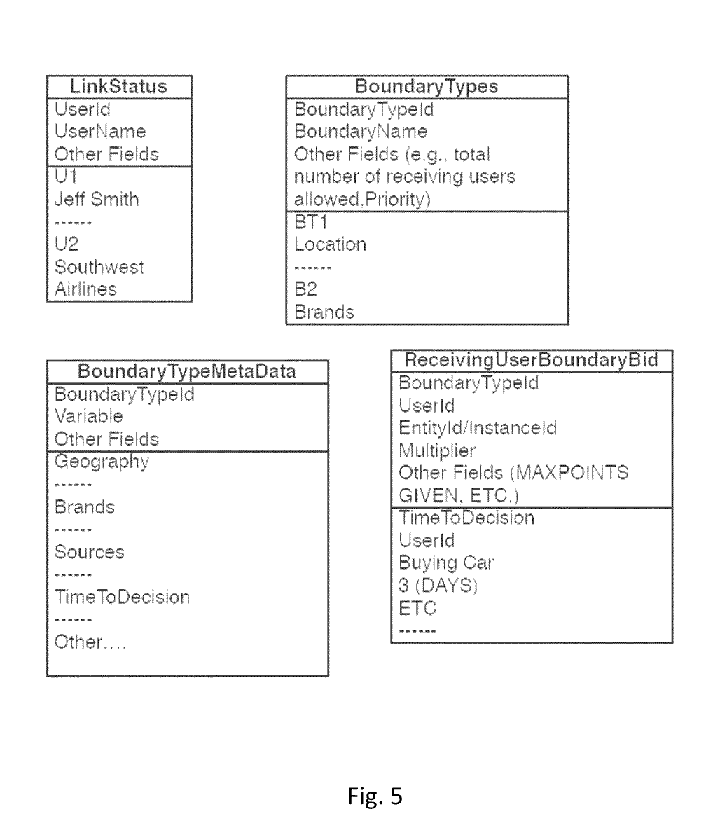

For Status Based Content Transfer 600 as show in FIG. 6, this also may apply to content which is generated by a second User related to a specific (Instance) and can be transferred to a third User based on Status. Additionally, other parties can change status of the Instance for the user A.

Additionally, the status of an entity or instance, in addition to associated content, may be viewable using so-called augmented reality. For example, a user who has a status of “buy” for cars may see prices or other associated content in an augmented reality engine such as a mobile device, specialized glasses, etc. for related cars which have a status of “Sell”. Or, vice versa, a car dealer would be able to view “buy” related content for users who have a status of “Buy” who are in their dealership. Additionally, associated reward points could be visible using such an apparatus possible only if there was a corresponding status match, allowing, for example, car dealers to determine how serious a potential buyer is who has entered their dealership. However, in this example, they would need to have a corresponding status match (e.g., the appropriate car, price, etc.) in order to view their status and associated information. This example also is relevant for other domains such as a factory manager navigating their shop floor (viewing status and related content for each machine), a potentials salesman at a convention (viewing status and related content for individuals who are attending the convention), etc.

For example: User A changes their status to “fixing” car. User C, a repair shop, posts content related to “fixing” the car. Content is visible to user A but not visible publicly. User C changes status on User A's Car back to “using” from “fixing”. User A changes status on car from “using” to “selling”. User B, is not aware of user A, changes status to “Buying” car. User B can now see user A Car content, including the repair associated content. User B buys car. User A transfers car to user B, including content which was generated for User A's car. User B now has control over content and status of car.

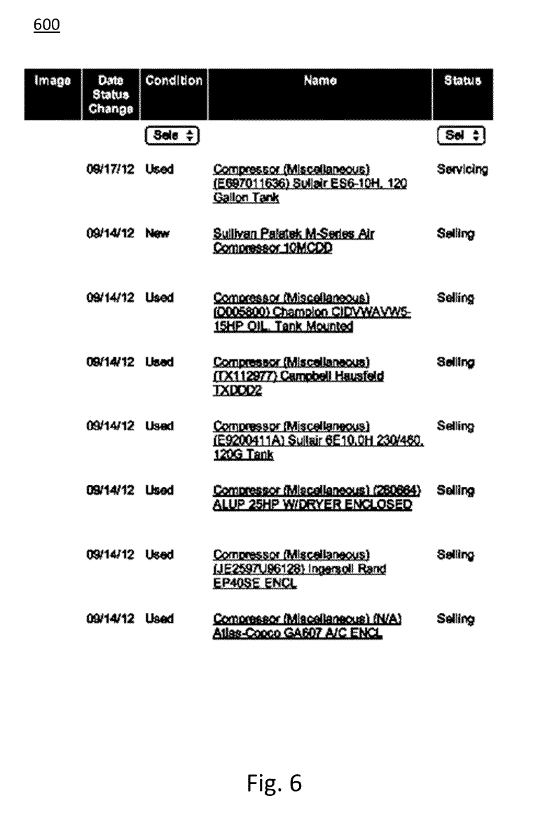

In a Status Based Content Escrow embodiment 700 as shown in FIG. 7, another extension of the present invention would be to put any content in “content escrow” where content would not be displayed publicly, would be removed, or modified when, if, or until a certain pre-condition status was met.

For example: Hilton loses user A's hotel reservation. User A changes status of Hilton (perhaps as specific to the reservation) to “pending dislike”. User A posts a negative review of Hilton. The Review is not published publicly. Hilton changes their status in regards to User A's reservation to “Investigating”. When Hilton changes status to “Done investigating” or User A changes status to “Dislike”, review is published. Note that in this instance, it may be that as a pre-condition to the reservation, the user agreed not to post anything negative about their experience in regards to this reservation until Hilton has the ability to address the issues.

In another example: Note that the status can be in relation to a brand, person or even a specific instance of product. So, for example, “my Corvette VIN 121212121”. This may be a unique feature of the invention in that the status is not just about “a user” but it is more how “a user” relate to another object. So, for example, “Selling My Car VIN 1212121” or “Buying A Car”, etc. A user can post a status to just one instance or to many instances at the same time.

In another example, User A may post a review about a software application complaining about a lack of a specific piece of functionality of the software. User A, at this point, may change their status in relation to the software to “using/dislike”. In this example, the status is dependent on the functionality existing or not existing. Additionally, the User may elect to allow the Software manufacturer a period of time to rectify the issue (“Fixing”). If the Software manufacturer adds the functionality (“Fixed”), the system may automatically view the coding files based on keyword to determine if the functionality has been added or hasn't been added, so that the review is displayed or not displayed publicly. Alternatively, the review may have been subject to other business rules such as only to be initially displayed to other users who also have a status of “Using/Like”, for example. In this example, the Software Company would have had time to rectify the problem before the content was displayed publicly or at least limited the visibility to only users with a specific status in relation to the Software.

For a currency dependent status changes another layer of credibility can be added to this transaction by applying currency where the users will gain or lose depending on the 1) Outcomes of the status and/or 2) The credibility of the status.

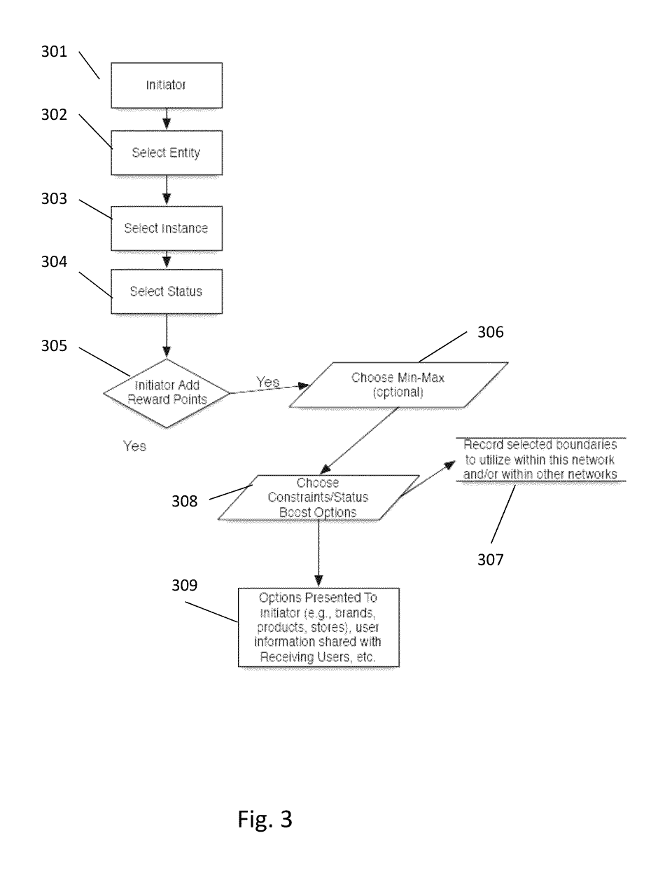

Now referring to FIG. 3, an initiator 301 selects and entity 302, instance 303, and a status 304. The initiator 301 adds reward points 305 and chooses a min-max setting 306 if desired. The initiator 301 chooses constraints/status to boost options 308. Select boundaries are recorded to be utilized within this network and/or within other networks 307. Options 309 presented to the initiator include brands, products, stores, etc. which the user may elect and share with receiving users. In some executions, reward points may be automatically associated with a status update. In FIG. 3, boost options 308 are used, however, other bid types can be sued such as flat absolute value bids.

For example: User A sets status of a car to “Buying”. User B, C, D set status of car to “Selling”. User A is presented with a choice to pledge a currency amount which would accompany the status. User B, C, D are also presented with option to pledge a dollar amount which would accompany the status. If User A changes status under the required terms, they will lose the dollar amount.

In another example, User A Deposits $100 (or other form of asset) to commit that the status will change to “Bought” for a car within 3 days, in return for $200 additional discount by User B or User C or User D for example, if they change their status in relation to User A Car to “Sold”. If the user does not change status within set time period, the asset will be disbursed among User B, C, D. In the same example, user A may choose to pledge $100 but be rewarded $500 (an additional $400) for limiting the associated status set to only user B and User C, which B and C have agreed to at the time of setting their status or later if proposed by User A. Again, in this example, if User A decides to open up the “bidding” to user C or does not change status to “Bought” for the car, the User will lose the $100. If the User A does not buy the car, a portion the $100 which user A pledged will go to User A, B, C. If the User A DOES change status to bought and user B does change status to Sold, User B, C, D will subsidize the status change for User A and User B.

The system relies on User B, C, D to confirm that the status changed or did not change for user A. In certain instances, all “Selling” users must agree to monitor the status change of User A, whether they were part of the status negotiation or not. Additionally the buying User may agree to be monitored so to determine no status change took place (e.g., GPS tracking to insure that they do not leave the area, or that they do leave the area, or credit card monitoring, etc.).

This same currency-backed process can be utilized for non-commerce related transactions. For example, going back to the Airline X example, a user can change their status to “Using-Negative” and Pledge 100 points related to a specific trip. At that point, the user may post specific content, which would be grouped under the negative-status. (e.g., @Airline X, a user lost my luggage!). They may be able to Pledge a currency amount, which may or may be subject to a pre-determined range. Additionally, they may or may not be presented with options to “Boost” their reward Reward.

The content may or may not be immediately publicly viewable, depending on options associated with the Users or with the status. For example, perhaps Airline X has paid additional money for the right to view content associated with a negative status prior to public display. Or, for example, the user may elect to receive a higher “boost” in exchange for delaying the public display of the content. Or, for example, a minimum number of points must be Pledged before content is viewable.

Airline X, may change status to “Researching” associated with that specific trip. Or, perhaps, they may not need to change their status in relation to the original user status. However, they may elect to investigate the user Status, for example by: 1) Contacting the user to confirm the content, 2) Electronically determining whether or not the content is valid (e.g., matching against sales data, etc.) 3) Using a third party to confirm the claims 4) Asking follow up questions electronically to determine the validity of the content, and/or 5) Checking content against other third party data usually with User permission (e.g., telephone records, user GPS location data history).

Additionally, certain aspects of this transaction can take place “prior” to the service/product, as an agreement between the two users. For example, User A may agree not to post any negative items (relating to a negative status) before User B (Airline X) can review the information, in return for Reward Points and/or a discount on a current or future transaction. Additionally, User A may agree to post potentially pre-determined content if no negative status is elected after a trip. In other words, User A will post, for example, “Airline X is great, just had a great trip!” if there is a lack of a “negative” status change after the instance of the trip has occurred.

Similarly, this transaction-type can be used in market research. A company may provide points for specific users with specific status to answer custom questions (or custom status options) related to one of their drugs. In this case, for example, the entity for which the status is based on is the combination of a health condition and a product. For example, Pharmaceutical Company A may provide 100 points for users who have a status of “Trying to use Drug A on their Heartburn” to answer questions. In this case, the status may be driven by electronic medical records, including efficacy data, in order to prove how the user was using the drug. After the user answers the questions, the visibility of the answers to the questions may change depending on the status of the user. Additionally, associated electronic medical data logs, may be visible or not visible to a second company, depending on the status of the second and first company in relation to the User. For example, Company A may ask questions related to Drug A and use these answers for market research purposes. In this case Company A may be allowed to directly assist User A with the therapy, (with User A's permission or, for example, with a pre-defined criteria based on usage data—e.g., not using the drug correctly—which would allow Company A to intervene to try to rectify the problem. If the intervention by Company A fails (based on pre-defined criteria or when the User changes their status to), than Company B may be allowed to solicit the user. In this case, for example, some or all of the initial market research questions may be allowed to follow the User with Company B, along with some or all of the associated medical record logs. Additionally, some of these responses, as well as the entire interaction, would potentially become public. One benefit of this interaction for Company A, Company B and the User is that the User does not need to answer the same questions and provide the same data repeatedly.

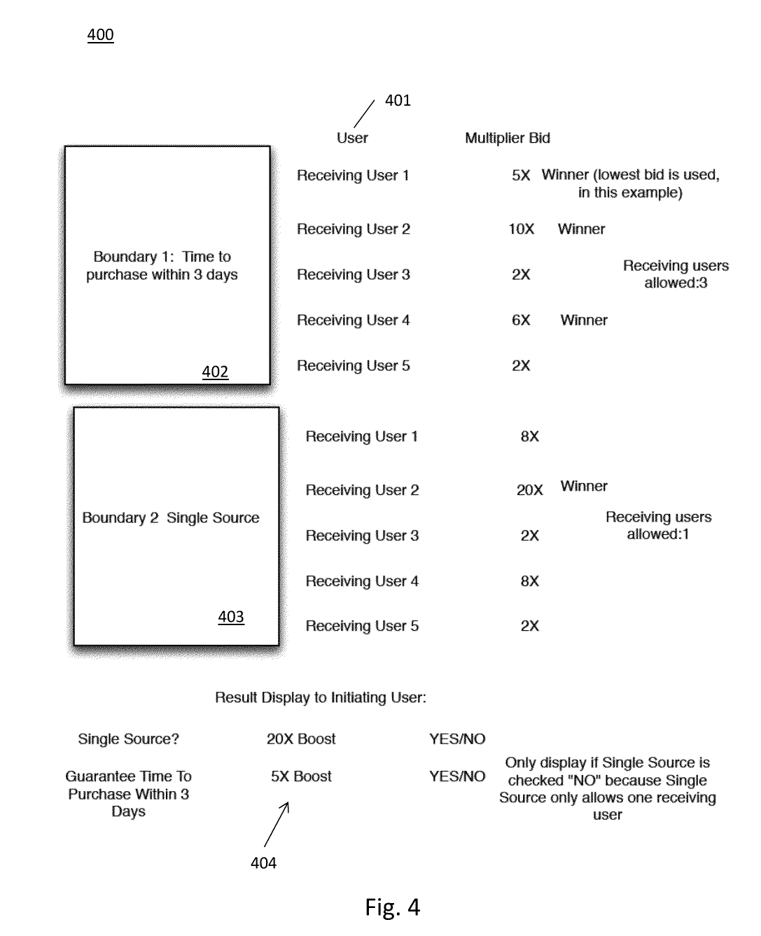

Now referring to FIG. 4, a buy example 400 is illustrated. A User 401 selects an Entity. The User 401 Chooses a Status (In this case: Buy). The User 401 makes a Base Status Pledge (points, money, etc.). The Display shows a min/max allowed depending on the product category and a choices based algorithm. The Minimum Status Pledge may be a minimum pledge by a corresponding seller, average of sellers, and/or take into account other factors. The User Base Status Pledge Reward is Displayed. If the user completes transaction, the User pledges 100 points. The User will get 200 points when status changes to bought or will lose 100 points if status does not change to bought (Positive Transaction). This can change dependent on the category. The User chooses Boundaries 402 and 403, each Boundary 402 and 403 chosen will provide for a Boost 404 such as time limit, source limit, or tracking to place a cookie on browser to insure that no other store is reviewed, tracking phone to insure no other physical location is checked; and an Algorithm to determine past behavior/future behavior to insure compare against prior history, Price Limit, Geography Limit (similar to source limit), and Check-Ins.

FIG. 4 illustrates an example data model for currency based boundaries 400. The selected entity or instance is buying a car. The first boundary 402 set is the time within to purchase or complete the instance, here three days to purchase a car. The first boundary 402 is distributed to a plurality of users 401, which then return bids. A second boundary 403 is set as “single source” which only allows one receiving user. For the first boundary 402, three receiving users are allowed and three bids are declared winners and receive a 5X boost. For the second boundary 403, only one is displayed to the initiating user and that winner receives a 20X boost.

FIG. 5 illustrates the link status 501 which contains the userid, username, and other fields. In this example the first user is Jeff Smith. BoundaryTypes data 502 includes the boundarytypeid, boundaryname, and other fields. In this example there are two boundaries, one for location and one for brands for the car buying example. Boundarytype metadata 503 includes the boundarytypeid, variable, and other fields such as geography, brands, sources, time to decision. The receivinguserboundarybid 504 includes boundarytypeid, userid, entityid/instanceid, the multiplier, and other fields. In this example they are the time to decision, userid, buying car, and 3 days.

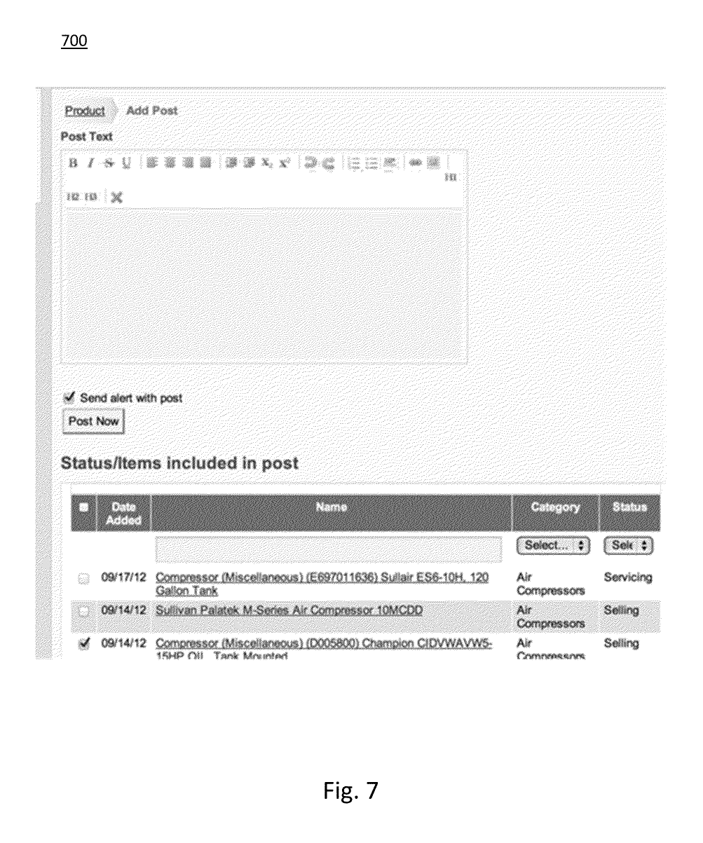

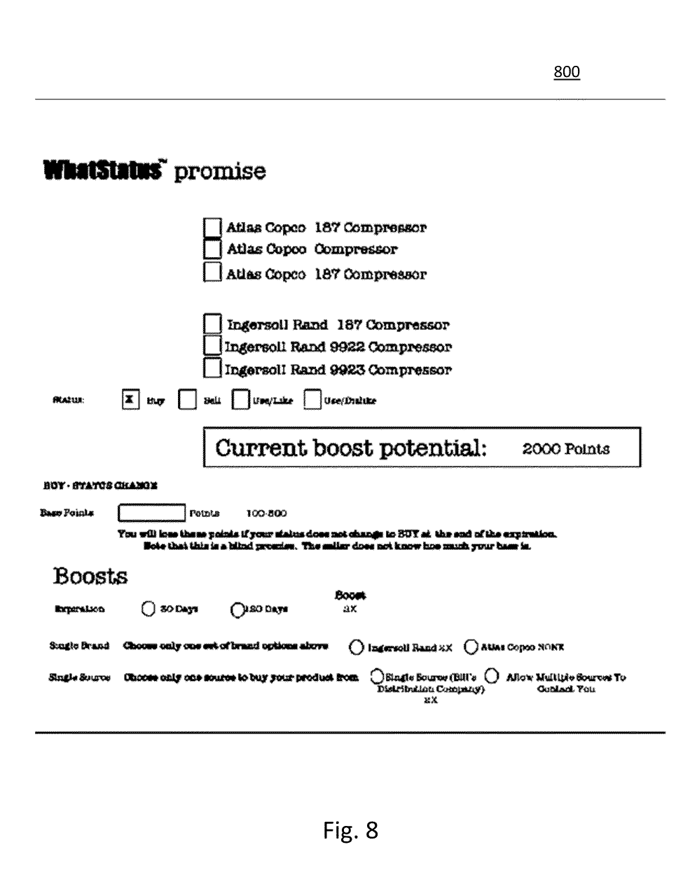

Now referring to FIGS. 8-9, a sell side 800 is illustrated. In this example, the seller chooses and entity. The Seller choose status (in this case: sell). Pledge Points are optional provided with a Minimum/Maximum for a category/product/entity/instance. The seller must indicate whether the seller has physical Possession. Why? For example, potential additional cost to change status to a status they do not have Possession Or, potential limits by manufacturer of product who may have paid to shut out sellers who do not have physical stock of item (e.g, if a manufacturer wants to control distributors, etc.)

Next the Seller chooses boost levels/Boundaries as previously taught. The Seller provides additional payment and/or rewards to Buyer for buyer choosing boundaries on transaction. Some boundaries can be purchased/decided in advance. For example, for boundary on a specific user that whenever User A sets status to Buy for a specific Entity, that User is only shown this company as a source. The Seller can also provide additional incentives by reserving currency rewarded to be used only on it's products/services. For example, Seller of Car can provide 5× Boost if points are applied toward Seller Cars or other services at a later date.

In this example: a Buyer may lose if there is no Positive Transaction. The Seller also may lose if there is no Positive Transaction (as opposed to other systems, where buyer gains—e.g., commission—if there is a Positive Transaction. This is only possible because the system is tracking the status of both Buyer and Seller. Seller is motivated to accept connections only for Positive Transactions. The Buyer is motivated for a Positive Transaction. Since there is a Base Pledge on the line, buyers are likely to be more motivated.

The present invention also teaches Permission/Posting Options for a third party user, User C, to contact a first party user, User A based on the relationship of a status entity of User A related to a second party user, User B, as well as User B's relationship to the entity and User B's Relationship to User C. In other words, User A “Dislikes/Uses the Auto X”, user B (Brand X) is “Manufacturing Brand X Autos”, but has not updated the Auto X. User C (a competing brand, Brand Y) is Manufacturing Brand Y Autos. User C can post to User A while User A dislikes the Auto X and User B is manufacturing Auto Xs with no update by user B to the Auto X (in this case an update by User B (F Brand X) may be a response to the “dislike” or even an update to the product itself. When User B updates their Auto X, User C can no longer contact User A Regarding their Auto X. In this example, User B and User C are “competitors” and thus this relationship defines the ability to contact User A under certain conditions of User B and User C. This “ability to contact” may also extend to content restrictions on other networks. For example, if User A visits User C's web-site, the content on User C's website related to the Auto X will be “restricted” to User A. The restricted content may be specific elements of the web-site (e.g., Price of a specific product), or—for example—all of the content on a web-site. In this case, the the system may have places a cookie on User A's computer which communicates to User C's web-site which content to display or not to display based on User A's status to Auto X, for example.

### Example Architecture

### Nomenclature

All tables, fields, variables, etc. start with lower case, new word upper case. Classes start with capital letter. Table names, class names will only have a plural if it is just one word for example “Users”. However messageUser will never have any plurals. Classes that call second classes when instantiating objects. The variables use the second class name. (not the tableID though)

For example . . . If ProductInstance uses Product or ProductInstance user ProductStatus (second example). ProductInstance->productName (from the Product class). ProductInstance->productProductStatusName (name is from the ProductStatus table/class). Always use variables directly in scripts. When using non variables, such as name, description, etc. a user can refer to the class. The reason is that a user can get the variable many different ways, often within different classes, so it gets confusing.

### Architecture

The structure of the system is based on “status” and “entity”. Although there is no actual “Entity” table, entitys can be anything that has a status.

ProductInstance—Is a specific product which a User actually has possession of. In other words, it is an instance of a product, with a serial number, etc.

UserProduct—Is a user-product combination. In other words, if I want to link myself to an iPod, but not a specific iPod, this would be in UserProduct.

Every entity has only one status at a time (although future functionality: more than one status). Even a status such as “using” may also have another notion with it such as “Like”. So a user would have the choice between Using/Like or Using/Dislike.

Entity's can also have owners, (use userId) at the productInstance or product table. For example, for the entity “iPhone”, the User Apple would own the entity.

NOTES: “entityDescription”: All entitys have a instance variable called entityDescription which can be accessed as a display variable. For example, a productInstance will need product name and serial number displayed for a user to understand what it is. So . . . entityDescription would be iPod (12121222).

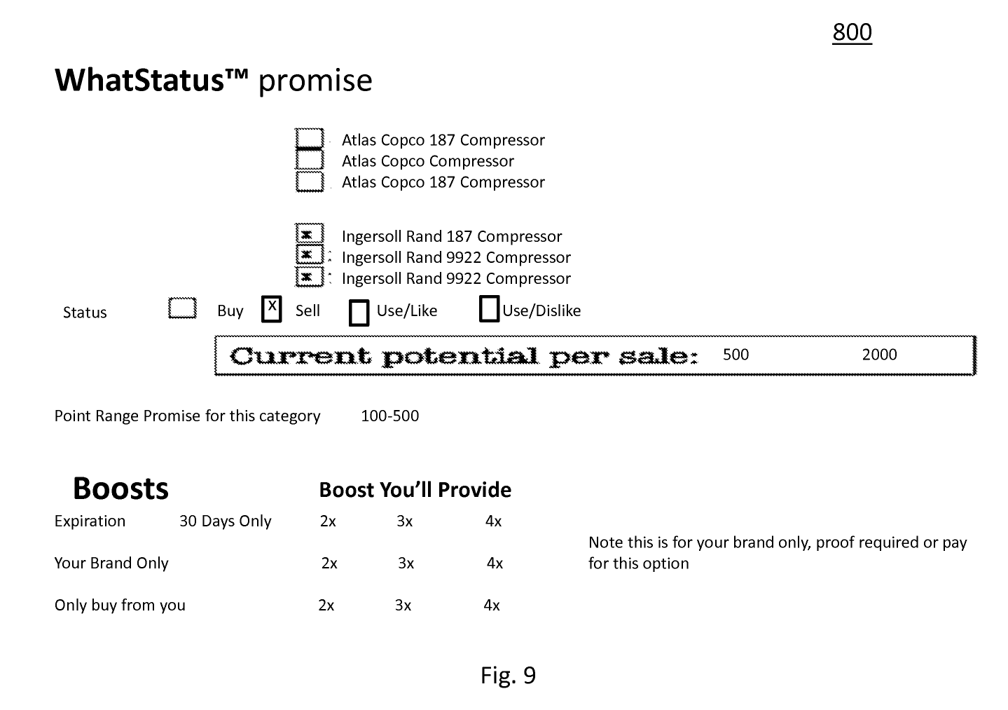

LinkStatus 1001 is the main table, as shown in FIG. 10, which will associate entitys with their respective status. All status is kept in the linkStatus table. linkStatus links entitys to status. Note that each entity has its own ID field, and then a corresponding statusId. For instance: Buying (statusId), iPods (userProductId), productInstanceId=null; Selling (statusId), userProductId=null, my specific ipod (prouductInstanceId). Note that entityDescription can be accessed in this class, which will refer to the entityDescription in the appropriate entity.

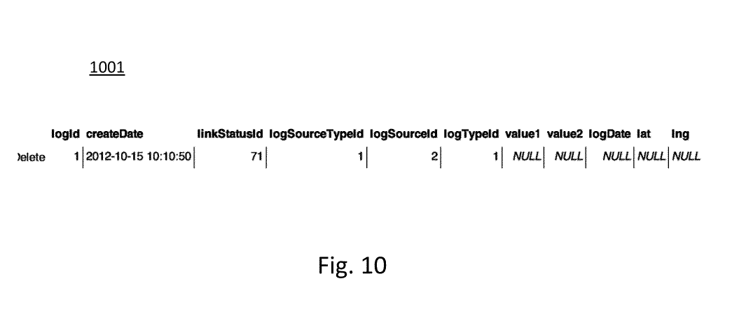

LinkStatusPost 1101—Links a status to a post (and, also, relationally to an entity) as shown in FIG. 11. In other words, “Can't wait to sell my iPod” would be associated with a linkStatusId. This way, the system can tell what specific status was when the post was generated, and also of course what entity it relates to through the linkStatus table. Similar: linkStatusImage, linkStatusResource

Accessing detail information. Usually a user can access information about an entity by using the entity ID or the linkStatusId (and obtaining the entity ID from the linkStatusId).

AssociationUser Defines relationship between users (users may also be brands, companies, etc.). AssociationUserTypes include, for example, Competitors, Partners, Suppliers, Distributors. For example, userA and userB may be defined as competitors, UserA and UserB may be defined as suppliers.

AssociationCategory (or AssociationFamily) Defines relationship between categories. AssociationCategoryTypes include: Complements, Substitutes, etc. For example, category1 and category2 may be complements (Tires and Cars). For example, category3 and category4 may be substitutes (Airlines and Trains).

AssociationStatus tracks associations from one general status to another and rules with each relationship. Point (currency) data information, such as max points allowed, etc. StatusIdFrom, StatusIdTo, visbilityAllowedFrom. contentEscrow. For example: Buy to Sell, Buy to Use; Sell to Buy; and Use/Like, Use/Dislike.

AssociationStatusUser allows users to enter in their preferences related to status associations. Also may enter elapsed time to expiration and points/currency. AssociationUserId, userId. For example: User A may decide that for Buy to Sell, show related entity content only for users who have the sell designation; User A may decide that for use/like do not allow contact by Competitors to entity, but allow for use/dislike; User A may decide to automatically put in contentEscrow for anything for use/Dislike for anyone with all status, except the owner of the entity.

AssociationStatusUserLinkStatus. Same as above, but allows users to enter in rules for a specific status update for a specific entity. Additionally, there may be global values for the entire web-site forced on users for the above data. This may also be at the user, category level or, there may be additional fees for additional flexibility (for example, overriding user preference not to allow competitors to contact me).

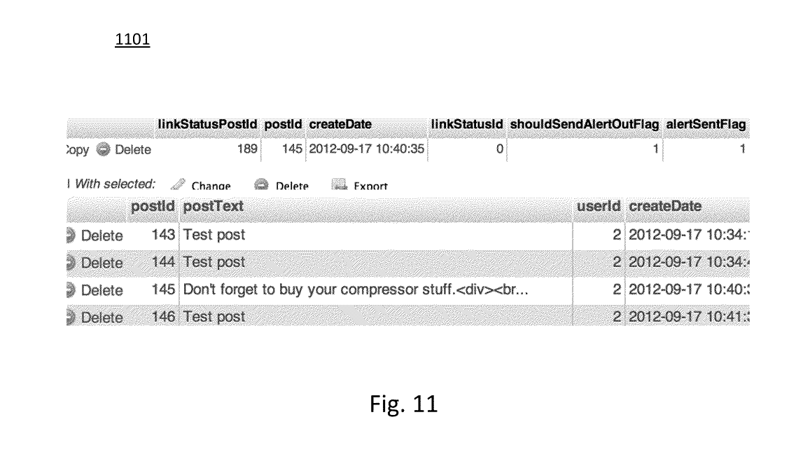

Posts 1201 are content which is generated for a specific entity as shown in FIG. 12. They are attached to a linkStatus. Posts will display on an entity detail page. Posts automatically get sent out with alerts by default when someone else is posting on a user linkStatus. For example, company A is repairing my productInstance. They post an update, it will be sent out as an alert.

For example, company B is posting my request to buy an air compressor. It will automatically be sent out as an alert. I post on my own entitystatus. It will not be sent out as an alert. Companies must have permission to post on someone else's status. A post can be attached to multiple linkstatus. An alert for a post is only sent once for a user. The system checks to see if an alert has been sent out for a specific user first before sending the alert again. A user can tell who a post is FROM—userId on the post table. A user can tell who a post is TO, by looking at the linkStatusId (who is the status for?) Posts may appear or not appear depending on status.

When a user inputs a linkStatus, they may also indicate a purpose. The purpose may also come contextually from other data (such as GPS location, usage information, etc.)

Images are uploaded to the Image table. uUerId tracks who uploaded the image. This is used, for example, to determine the branding of the email to send out. Images are linked to a linkStatus using the linkStatusImage table.

Broadcasts/Alerts—are sent out when certain things happen. For example, a resource is added, an image is added, or a post is added. Alerts are sent out via the Broadcast class. The broadcast class is responsible for generating the communications. The specialized content, audience (not the shell of the email) for the broadcast class is generated by the individual element classes. For example, an alert that needs to be sent out for a new picture. The audience will be determined in the productImage class, as well as the specialized content. The audience and content will be passed to the broadcast class which will create and send the communication.

Note that the broadcast class is always initiated by the main class and not vice-versa. Broadcasts classes are (will) be divided by message type, broadcastText. Broadcasts require: userId From, userId to, and siteId. Who is it from, who is it to, siteId=what branding should be used? Future functionality: other types of communications (e.g., push notifications).

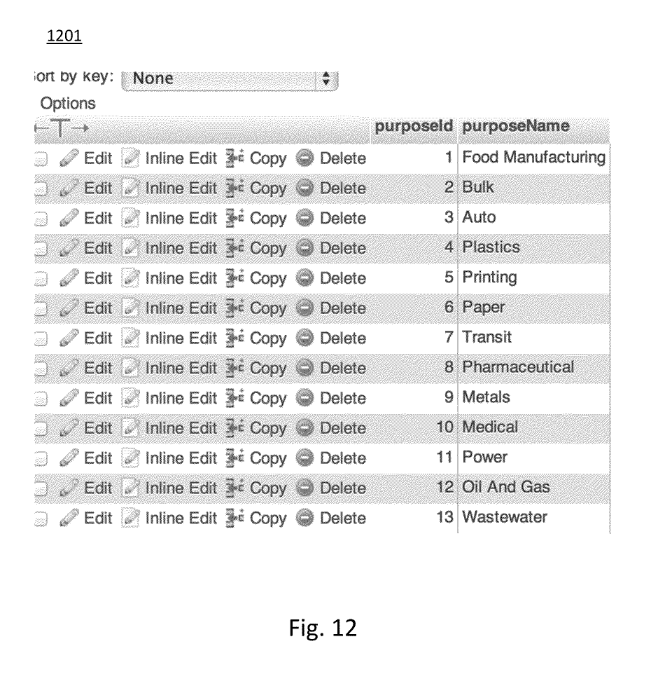

Log has a set of data from a product or ProductInstance. For example, the collection of GPS coordinates. Logs are attached to LinkStatusId as shown in FIG. 12. Logs follow similar business rules as Post. E.g., when status changes, users may or may not be able to view log data for a given Log. This table may be queried using a LinkStatus . . . or for users who have more visibility, they can query using productInstance or productId (obtained from the linkStatus table). FIG. 13 illustrates a table 1301 showing the attachment of a logIDs to linkstatusIDs.

Session[userId] is the main variable which tracks who is accessing information, uploading information, etc.

siteId/userIdSite=is the domain which is being accessed. Note that every site has a corresponding user associated with it, which is the userIdSite. BIGTRUCKS is owned by ABC Trucks. When Big Trucks is accessed, this is siteId-X. The data is pulled using ABC Trucks (userIdSite).

userIdChild—refers to any userId which is being accessed/manipulated by anyone other than the admin for that. If userIdChild is present, it will automatically replace any calls which typically use session[‘userId’]. This is used, for example, when Company A is adding a product for company B. Company B would be userIdChild.

Future: subUser. Multiple users can use the same username/password combination for a company. However, when a company wants to track multiple users they can set up subUser. If subUser is available, when a user logs in, they will also enter their subUser password. Additionally, subUser can be required or not required for a specific account. This will track specific activity at the subUser level. Note that subUser are not tracked for userIdChilds.

The non white label web sites will load index.php by default. If it is a white label website, than send to “profile” of userId, allowing log-in. Next, determine siteId from domain. Once siteId is determined, the userId is determined from siteId. Note that even though siteId is determined from userId, siteId is not used in any way except for tracking IN other words, all graphics, etc. are stored in uImages folder. sImages folder is currently not being used.

Sites may have a userAssociationIdThatIsRequired. If userAssociationIdThatIsRequired>0, then UserLogin will check to make sure that this association exists (e.g., that a user is an “account”). If not authorized, the user will be kicked to login with a corresponding message.

The privacy class is set using userIDParent and userIdChild. StatusIdArray status that userIdParent can view. If all status can be viewed, statusIdArray will be null. If userIdParent and userIdChild are the same, statusIdArray is automatically null. For a given linkStatusId, privacy roles are determined by the id as well as the relationship between the two users. For now, account owners have access to every linkStatus. For now, if siteId< >0, even if it is a user own.

A class is a set of users. Users are assigned to one class. This allows them special access or restricted. There may be other fields which dictate what access privileges a user has, in addition to a class requireApprovalOfProductsOwned—forces approval of all products which they are the owner.

Status are assigned to a class. For example, KING may have access to the following status: Sell, Buy, Buy/Sell, User, Want. But QUEEN may only have access to Sell, Buy. Some products require that the ownerUserId assigned to the product approve status related to the product. This can be overriden using allowAnyProductFlag, which is only associated with a status (for example, “using” will almost always be allowed.

Future: Some product require proof of ownership, in which case, this should be here. For example, proofOfOwnerShipTypeRequired or something like this. Status will be put in a que.

Future: each status/class may have a points value. (cost to post to this status).

When a status is placed in a queue, the appropriate flag is flagged waitingProofOfOwnerShipTypeRequired=1=waiting for approval, 0=not approved. Every category belongs to a family. The family will drive how the information displays and what status is available. For example, each status belongs to a statusFamily. Each category is assigned to a family. When product is accessed, get category, then get family, then get status associated with that family.

Instance images are stored in /pImages/—the productId is the first characters followed by underscore, image type, etc. (defined in the ProductImage class in several places, and in image_functions.php—$path variable). Note that product images persist past a user relationship, which is why there is no user information attached to the image. User images such as logo, etc. are stored in uImages. The pattern is userId followed by an underscore. General images are stored in /images. General email images for email templates are stored in eImages. Images may have similar rules to Points.

Points (table example). When user sets a status, they can pledge between min and max points. Users compete to follow status: How much discount if time period; How much discount if they are the only. This is where “ACCOUNT” may get the best multiple, the user will lose nothing if they decide not to buy, etc. And they have access to how much they bid. However, the may not be able to re-bid for 30 days. Points are stored in PointTrigger table. PointsTOGive, Max TriggerId, TriggerName, Criteria, CriteriaType. Criteria may be, for example, “Buy” and CriteriaType may be “Status”.

Associations are defined by parent and child and are in the userAssociations table. Association type defines what the type is. Account means that this user was actually added by another user. Their products were also added. The parent account will always be a white label branded site for the child account. Any time there is any activity for this child account, it will be branded by parent account.

Future functionality: allow child account to be removed by parent and put in the main site.

ExternalId—this is an Id from a CRM system, for example.

SendAlerts—calls specific methods of a main class (e.g., ProductImage), which then calls the broadcast class.

Product instances are specific instances of products. They have may or may not have serial numbers. There is a description associated with the instance, which should be a permanent part of the instance

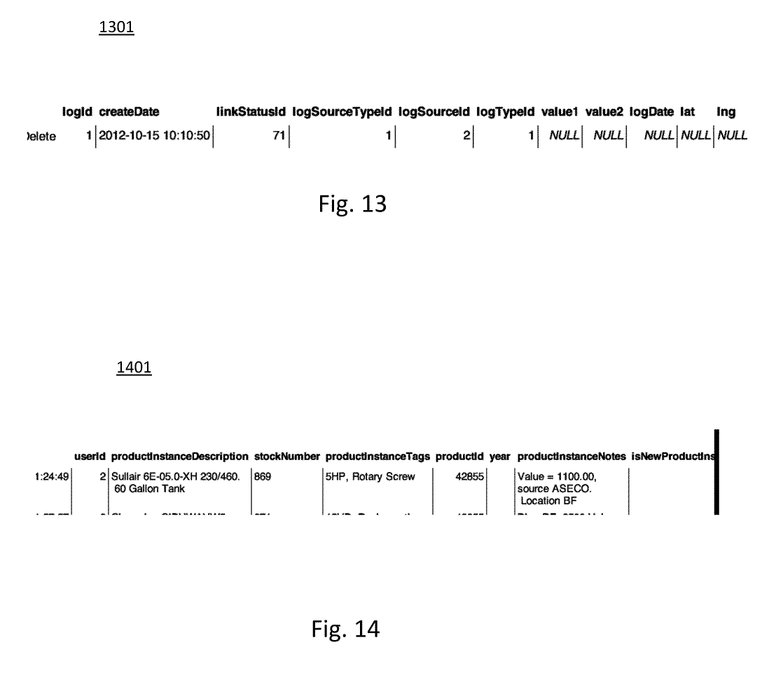

There are also tags as shown in FIG. 14. Tags 1401 are custom categories for an instance (e.g., for a car, it could be color, etc.). Currently they are not different or labeled by a product category . . . however they perhaps should be and perhaps may or may not be transferred along with a productInstance which is transferred from one user to another. StockNumber—is the user internal stock number. This should NOT get transferred with a productInstance. MonitorId/source—Id of monitoring service, electronic monitoring. This does not get transferred. Note that anything permanent should go into description (anything non-permanent, eg condition or hours should go into the productStatus field—notes.)

Anything without a brand unique is a Miscellaneous Product. Potential—add categoryid and brandId to productInstance. If productId null, construct product name with brandId and categoryId. This will allow miscellaneous products. For now, though, the system added a miscellaneous product in the product table for each brand/category combination. The system know it is misc because there is no brandUnique.

Resources are instructions, etc. which are at the productInstance level. It can be an upload to our servers or can be a link somewhere else. Resources are saved in the folder pResources using a random string+file type. Similar business rules to Posts.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention. The method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for automatically updating content, status, and comments on third parties executable by a machine and rendered on the display of the machine, comprising the steps of:
receiving a comment from a first user, User A;
setting a status on the comment;
determining whether to publish or display the comment to public users;
displaying the comment to public users;
receiving input from a second user, User B;
changing or updating the status of the comment;
applying content display rules to users who are not involved in the status;
determining whether to continue to display the comment to the public users; and
hiding the comment from the public.

2. The method of claim 1, further comprising the steps of:
receiving a status change from a user regarding a transaction;
publishing the status change;
confirming the action of the status change;
validating the content related status;
receiving a second status change from a user;
hiding the previously displayed comment from the public;
receiving a third status change form a user; and
displaying the status change and all previously hidden statues by the user related to the same parties in the transaction.

3. The method of claim 2, the step of confirming the action of the status change further comprises the steps of:
using a receipt for the transaction; and
using an RFID/scanner can be used to check serial number on a physical item;

4. The method of claim 1, further comprising the steps of:
receiving a first change status from a first user in relation to an item for sale;
receiving content from the first user about the item
publishing content from the first user about the item to a plurality of public users;
determining matching or complementary statues based on pre-defined business rules with respect to the item and the status;
matching the status of a public user to that of the first user; and
displaying the status of the first user to one or more public users with a matching or complementary status.

5. The method of claim 4, further comprising the steps of:
receiving additional or supplemental information about the item from a first user;
publishing additional or supplemental information about the item until a status change is received;
displaying the content to the public until the first user changes their status based on pre-defined business rules with respect to the item; and
hiding the comment from the public as a result of a status change by the first user based on the pre-defined business rules with respect to the item.

6. The method of claim 4, further comprising the steps of:
receiving a new or changed status from a public user previously matched to a first user; and
hiding the first users content form the non-matching public user.

7. The method of claim 1, further comprising the steps of:
placing any content received in a content escrow;
hiding content stored in the content escrow from display until a certain pre-condition status was met;
periodically checking content held in the content escrow for a pre-condition status;
publishing content if a pre-conditions status is met; and
removing published content is a pre-condition status is met.

8. The method of claim 1, further comprising the steps of:
adding a layer of credibility to a currency dependent status change;
applying currency where the users will gain or lose depending on the outcomes of the status and the credibility of the status;
pledging a currency amount to a status; and
changing the status under the required terms results in a loss of the currency amount.

9. The method of claim 8, further comprising the steps of:
presenting a first user with a choice to pledge a currency amount which would accompany the status;
presenting one or more other users with the option to pledge a dollar amount which would accompany the status;
if the first user changes status under the required terms, they will lose the dollar amount; and
if the first user does not change status within set time period, the asset will be disbursed among the other participating users.

10. The method of claim 9, further comprising the steps of:
monitoring the user to determine if no status change took place.

11. The method of claim 1, further comprising the steps of:
pledging a number of points to a specific goal or transaction by a first user;
changing the status of a first user, secured by their pledge;
presenting the option for a pledging user to boost their reward or pledge.

12. The method of claim 11, further comprising the step of:
determining if the content is to be immediately publicly viewable, depending on options associated with the users or with the status.

13. The method of claim 1, further comprising the steps of:
providing the right to view content associated with a negative status prior to public display by a user; and
providing a higher “boost” to a user in exchange for delaying the public display of the content; or
requiring a minimum number of points to be Pledged before content is viewable.

14. The method of claim 1, further comprising the steps of:
contacting the user to confirm the content;
electronically determining whether or not the content is valid;
asking follow up questions electronically to determine the validity of the content; and
checking content against other third party data.

15. The method of claim 1, further comprising the steps of:
agreeing not to post any negative items relating to a negative status by a first user before a second user can review the information, in return for reward points and/or a discount on a current or future transaction; and
agreeing to post potentially pre-determined content if no negative status is elected after a transaction.
